(19) United States
(12) Patent Application Publication
(10) Pub. No.: US 2010/0274584 A1
(43) Pub. Date: Oct. 28, 2010

(54) Method and system for presenting and processing multiple text-based medical reports

(76) Inventor: Hyong S. Kim, Pittsburgh, PA (US)

Correspondence Address: Ansel M. Schwartz;Attorney at Law, 201 N. Craig Street, Suite 304, Pittsburgh, PA, 15213, US

(21) Appl. No.: 12/386,820

(22) Filed: Apr. 23, 2009

(51) Int. Cl. G06F 17/30; G06Q 50/00; G06F 17/27; G06N 5/02

(52) U.S. Cl. 705/3; 704/9; 706/47; 707/E17.032

(57) ABSTRACT

A system for processing medical reports includes a network. The system includes a plurality of EMR systems. Each EMR system has an EMR database and an EMR processing unit. The processing unit of at least one EMR system generating a text report for a patient. Each EMR system remote from each other EMR system and in communication with each other through the network. The system includes a controller having a controller database and a controller processing unit which automatically collects the text reports for the patient from the plurality of EMR systems, or produces text reports for the patient from data in the EMR database of at least one EMR system. The controller maintains a linkage for each report between the controller database and the EMR database from which each report arose. A method for processing medical reports includes the steps of generating a text report for a patient with a processing unit of at least one EMR system of a plurality of EMR systems. Each EMR system remote from each other EMR system and in communication with each other through a network. There is the step of automatically collecting with a controller processing unit of a controller text reports for the patient from the plurality of EMR systems, or producing text reports for the patient from data in an EMR database of at least one EMR system, the controller maintaining a linkage for each report between a controller database and the EMR database from which each report arose. A controller.

### FIELD OF THE INVENTION

The present invention is related to a method for processing medical reports. (As used herein, references to the “present invention” or “invention” relate to exemplary embodiments and not necessarily to every embodiment encompassed by the appended claims.) More specifically, the present invention is related to a method for processing medical reports from text-based medical reports.

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

Patient data such as the patient history and current status are recorded in text-based report by clinicians. The text-based medical reports are prevalent form of storing patient record. There are numerous efforts to make these records in electronic forms. Old records are being transcribed and entered manually into the computer storage such as database. Two types of medical data entry exist today: text-based entry and form-based entry. The text-based entry consists of either typing in a free text report or dictated report later entered into the computer manually. The form-based entry requires one to enter the data according to the form field presented by the computer. The advantage of the form-based entry is that one can easily gather information across many reports as the context of the data is denoted by the form field associated with the data. The disadvantage of the form-based entry is the complexity of the form fields and a huge number of possible fields in the medical domain. This disadvantage makes the form-based data entry very difficult and cumbersome for many of the medical reports.

Medical data obtained through form-based entry are definitely easier to present them in a customized manner as the data are tagged with contextual information given by the form field. There are many products that support such presentation of form-based data. The challenging issues for the form-based systems are the data entry and mapping of clinicians data to the structured data. Due to complexity and variability of patient data, it is quite difficult to build a comprehensive form-based entry platform without overwhelming the clinicians. There are other systems based on machine learning algorithms. However, the accuracy of such systems is not acceptable for critical applications for health care industry. Even a small error could cause a fatal mistreatment. Text-based medical reports are preferred by clinicians.

A novel medical record presentation and processing technology is introduced that allows clinicians to get a quick access to the data from multiple text-based reports not only in terms of patient information but also a structured view of overall patient history and status. Instead of synthesizing the patient information from disparate text-based medical records, the key sentences, paragraphs, and phrases are organized without changing any content and present them in a unified manner so that clinicians will be able to process necessary information quickly and accurately.

### BRIEF SUMMARY OF THE INVENTION

A technique is disclosed that enables the presentation of medical information extracted from multiple text-based medical reports. While maintaining the integrity of the information in the text-based medical reports, the medical information in forms of sentences, paragraphs, or phrases are mapped to the pre-assigned categories according to the user requirement. The result of such presentation provides an overview of complete information from the text-based reports according to the categorization structure. This method of presentation and processing of text-based medical reports provides a simple means of presenting the history and status of patient health in a unified manner. A method presented here reorganizes the elements of the text-based medical reports according to the required categorization without changing its content. Clinicians would have an access to the critical information quickly without having to access and read entire text-based medical records.

The present invention pertains to a system for processing medical reports having health information about a patient. The system comprises a network. The system comprises a plurality of EMR systems. Each EMR system has an EMR database and an EMR processing unit. The processing unit of at least one EMR system generating a text report having health information for the patient. Each EMR system remote from each other EMR system and in communication with each other through the network. The system comprises a controller having a controller database and a controller processing unit which automatically collects the text reports for the patient from the plurality of EMR systems, or produces text reports for the patient from data in the EMR database of at least one EMR system. The controller maintains a linkage for each report between the controller database and the EMR database from which each report arose.

The present invention pertains to a method for processing medical reports having health information about a patient. The method comprises the steps of generating a text report having health information for the patient with a processing unit of at least one EMR system of a plurality of EMR systems. Each EMR system remote from each other EMR system and in communication with each other through a network. There is the step of automatically collecting with a controller processing unit of a controller text reports for the patient from the plurality of EMR systems, or producing text reports for the patient from data in an ENR database of at least one EMR system, the controller maintaining a linkage for each report between a controller database and the EMR database from which each report arose.

The present invention pertains to a controller. The controller comprises a data interface which retrieves designated medical reports from at least one EMR database according to identification parameters by which the medical reports are stored in the EMR database and stores the designated medical reports and the controller database. The controller comprises a knowledge report browser module that presents knowledge reports of patients which the knowledge report browser module creates from the patient's textbased medical reports. The controller comprises a text report analyzer module that analyzes the textbased reports and parses the textbased reports' formats and processes the text based reports' contents into a form such that the knowledge reports can be generated by the knowledge report browser module. The controller comprises a knowledge search module that provides a search into the contents of the textbased reports. The controller comprises a config and management component which configures and manages the knowledge report browser module, a text report analyzer module in the knowledge search module.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 shows processing and presentation of text-based medical report to the Knowledge Report.

FIG. 2 shows the overall system architecture.

FIG. 3 shows the Text Report Analyzer architecture.

FIG. 4 shows an example of the Knowledge Report organized according to medical specialty areas.

FIG. 5 shows an example of the Knowledge Report organized according to medical report types.

FIG. 6 is a unified system view of patient records from heterogeneous EMR systems.

FIG. 7 is a block diagram of a unified system architecture of the present invention.

FIG. 8 is a block diagram of the system of the present invention.

FIG. 9 is a block diagram of the system of the present invention.

FIG. 10 is a block diagram of the data processing of the present invention.

FIG. 11 is a block diagram of the data presentation of the present invention.

### DETAILED DESCRIPTION OF THE INVENTION

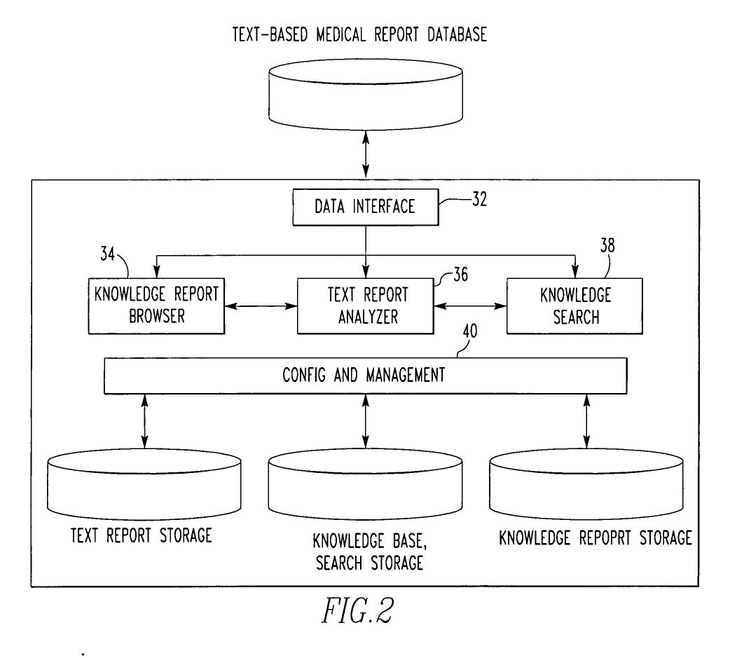

Referring now to the drawings wherein like reference numerals refer to similar or identical parts throughout the several views, and more specifically to FIGS. 2, 3, 6 and 8 thereof, there is shown a system 10 for processing medical reports having health information about a patient. The system 10 comprises a network 12. The system 10 comprises a plurality of EMR systems 14. Each EMR system 14 has an EMR database 16 and an EMR processing unit. The processing unit of at least one EMR system 14 generating a text report having health information for the patient. Each EMR system 14 remote from each other EMR system 14 and in communication with each other through the network 12. The system 10 comprises a controller 20 having a controller database 22 and a controller processing unit 24 which automatically collects the text reports for the patient from the plurality of EMR systems 14, or produces text reports for the patient from data in the EMR database 16 of at least one EMR system 14. The controller 20 maintains a linkage for each report between the controller database 22 and the EMR database 16 from which each report arose.

The controller 20 can have a controller network interface 26 and each EMR has an EMR network interface 19. The controller processing unit 24 communicates with the EMR databases 16 through the controller network interface 26 and the EMR network interfaces 19 to collect text reports of patients and store the text reports in the controller database 22 with an ID that identifies patients and associated text reports. At least a first EMR system 28 of the plurality of EMR systems 14 can be different from a second EMR system 30 of the plurality of EMR systems 14. The controller processing unit 24 can collect the text reports from the EMR systems 14 not based on a template or a data field. The first EMS system can contain only template-based data. The second EMR system 30 can contain both template based data and text reports. The linkage can include a direct linkage where the text report and the controller database 22 has an identification tag that maps a location in chronological information of the data and the EMR database 16 from which the text report arose.

The linkage can include an indirect linkage wherein the controller processing unit 24 replicates the text reports of the patient from EMR databases 16 to the controller database 22 and organizes them collectively when there are multiple sources for the text report from multiple EMR databases 16.

The controller processing unit 24 can check the integrity of the text report information by checking the byte size, date, and hashing of the text report content for signature matching to ensure that the data in the controller database 22 is exactly the same as in the associated EMR system 14. The controller processing unit 24 can collect text reports or data from the EMR system 14 in either batch mode or in real-time.

The present invention pertains to a method for processing medical reports having health information about a patient. The method comprises the steps of generating a text report having health information for the patient with a processing unit of at least one EMR system 14 of a plurality of EMR systems 14. Each EMR system 14 remote from each other ENR system 14 and in communication with each other through a network 12. There is the step of automatically collecting with a controller processing unit 24 of a controller 20 text reports for the patient from the plurality of EMR systems 14, or producing text reports for the patient from data in an EMR database 16 of at least one EMR system 14, the controller 20 maintaining a linkage for each report between a controller database 22 and the EMR database 16 from which each report arose.

There can be the steps of the controller processing unit 24 communicating with the EMR databases 16 through a controller network interface 26 and EMR network interfaces 19 to collect text reports of patients and storing the text reports in the controller database 22 with an ID that identifies patients and associated text reports. At least a first EMR system 28 of the plurality of EMR systems 14 can be different from a second EMR system 30 of the plurality of EMR systems 14.

The collecting step can include the step of the controller processing unit 24 collecting the text reports from the EMR systems 14 not based on a template or a data field. The first EMS system can contain only template-based data. The second EMR system 30 can contain both template based data and text reports. The linkage can include a direct linkage where the text report and the controller database 22 has an identification tag, and including the step of mapping a location and chronological information of the data in the EMR database 16 from which the text report arose.

The linkage can include an indirect linkage and there can be the steps of the controller processing unit 24 replicating the text reports of the patient from EMR databases 16 to the controller database 22 and organizing them collectively when there are multiple sources for the text report from multiple EMR databases 16. There can be the step of the controller processing unit 24 checking the integrity of the text report information by checking the byte size, date, and hashing of the text report content for signature matching to ensure that the data in the controller database 22 is exactly the same as in the associated EMR system 14. There can be the step of the controller processing unit 24 collecting text reports or data from the EMR system 14 in either batch mode or in real-time.

The present invention pertains to a system 10 for processing medical reports, as shown in FIGS. 2, 3, 6 and 8. The system 10 comprises a network 12. The system 10 comprises a plurality of EMR systems 14. Each EMR system 14 has an EMR database 16 and an EMR processing unit 18. The processing unit of at least one EMR system 14 generating a text report for a patient. Each EMR system 14 remote from each other EMR system 14 and in communication with each other through the network 12. The system 10 comprises a controller 20 having a controller database 22 having a pointer to the text report in the EMR database 16 and a controller processing unit 24 which uses the text report in the EMR database 16 for the patient at a desired time.

The controller 20 can include a data interface 32 which retrieves designated medical reports from at least one EMR database 16 according to identification parameters by which the medical reports are stored in the EMR database 16 and stores the designated medical reports and the controller database 22. The controller 20 can include a knowledge report browser module 34 that presents knowledge reports of patients which the knowledge report browser module 34 creates from the patient's textbased medical reports. The controller 20 can include a text report analyzer module 36 that analyzes the textbased reports and parses the textbased reports' formats and processes the text based reports' contents into a form such that the knowledge reports can be generated by the knowledge report browser module 34. The controller 20 can include a knowledge search module 38 that provides a search into the contents of the textbased reports. The controller 20 can include a config and management component 40 which configures and manages the knowledge report browser module 34, a text report analyzer module 36 in the knowledge search module 38.

The text report analyzer module 36 can comprise a text report parser module 42 that parses and partitions lines of text in the textbased reports into phrases, sentences, paragraphs and sections; and builds a catalog of all words appearing in the textbased reports. The text report analyzer module 36 can include a semantic analyzer module 44 that takes the catalog of the text report parser and analyzes semantics of sentences, paragraphs and phrases to classify each sentence, paragraph and phrase according to predefined medical categories. The text report analyzer module 36 can include a rule-based engine module 46 that manages all ruled bases. The text report analyzer module 36 can include a knowledge report manager module 48 that builds a knowledge report for each patient and updates an existing report with new and updated senses, paragraphs, or phrases.

The text report parser module 42 can parse the phrases, sentences, paragraphs and sections into subcategories, chronologically. It also can classify them according to negative sentences, and groups similar sentence based on a similarity metric and chooses a representative sends to be a group head, where the representative sentences are stored in the controller database 22 indexed with classification categories and keywords. All negative sentences within a category can be stored in a separate database table and the controller database 22 and all negative sentences are links to the EMR database 16 from which the sentence arose, or any information presented by the controller 20 from the controller database 22 contains exactly identical information as found in the text report in the EMR database 16 from which the data arose.

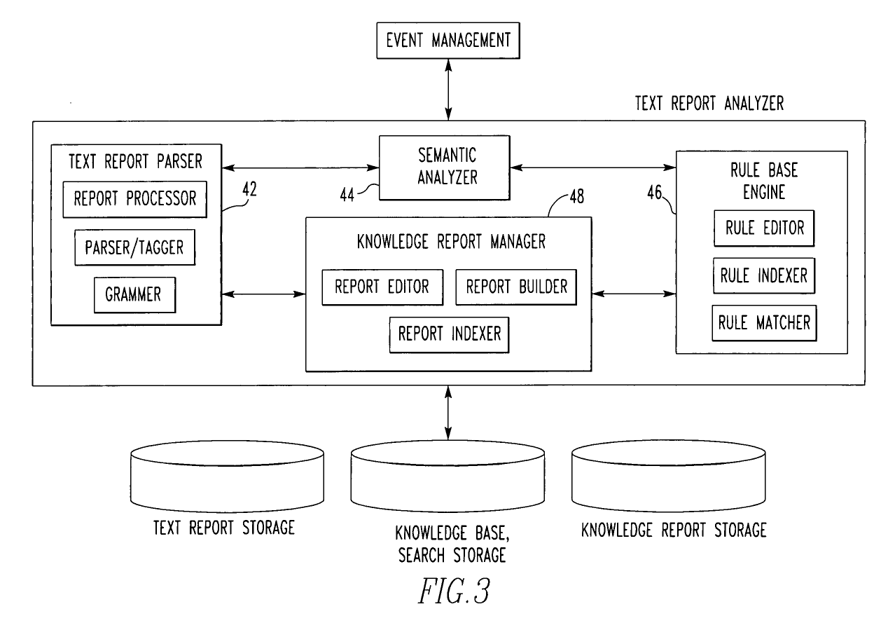

The present invention pertains to a controller 20, as shown in FIGS. 2 and 3. The controller 20 comprises a data interface 32 which retrieves designated medical reports from at least one EMR database 16 according to identification parameters by which the medical reports are stored in the EMR database 16 and stores the designated medical reports and the controller database 22. The controller 20 comprises a knowledge report browser module 34 that presents knowledge reports of patients which the knowledge report browser module 34 creates from the patient's textbased medical reports. The controller 20 comprises a text report analyzer module 36 that analyzes the textbased reports and parses the textbased reports' formats and processes the text based reports' contents into a form such that the knowledge reports can be generated by the knowledge report browser module 34. The controller 20 comprises a knowledge search module 38 that provides a search into the contents of the textbased reports. The controller 20 comprises a config and management component 40 which configures and manages the knowledge report browser module 34, a text report analyzer module 36 in the knowledge search module 38.

In the operation of the invention, a technique is disclosed that enables the presentation of medical information extracted from multiple text-based medical reports. Text-based medical records are entered in the storage of the computing devices. These text-based reports are parsed to identify sentences, paragraphs, and phrases. Sentences, paragraphs, and phrases are extracted and their relationships are indexed. The word count and data amount are noted from the original text-based report and compared to those extracted sentences, paragraphs, and phrases. The exact match of original data is verified in order to maintain the integrity of information in the extracted data set. Extracted sentences, paragraphs, and phrases are processed for categorization according to the preset rules such as keyword list, key phrase list, or more complex rules. The categorization depends on the user requirement. The rating of each sentence, paragraph, and phrase are made within the same category according to the configurable rules. Ratings could be based on a chronological order, word frequency, or any other definable metrics. After the categorization and rating are completed, the sentences, paragraphs, and phrases are juxtaposed within the category according to the rating. The highest rated sentence, paragraph, or phrase is shown in the presentation while others belonging to the same category are hidden but would be invoked later if needed. The result of such presentation provides an overview of complete information from the text-based reports according to the categorization structure. This method of presentation and processing of text-based medical reports provides a simple means of presenting the history and status of patient health in a unified manner. A method presented here reorganizes the elements of the text-based medical reports according to the required categorization without changing its content.

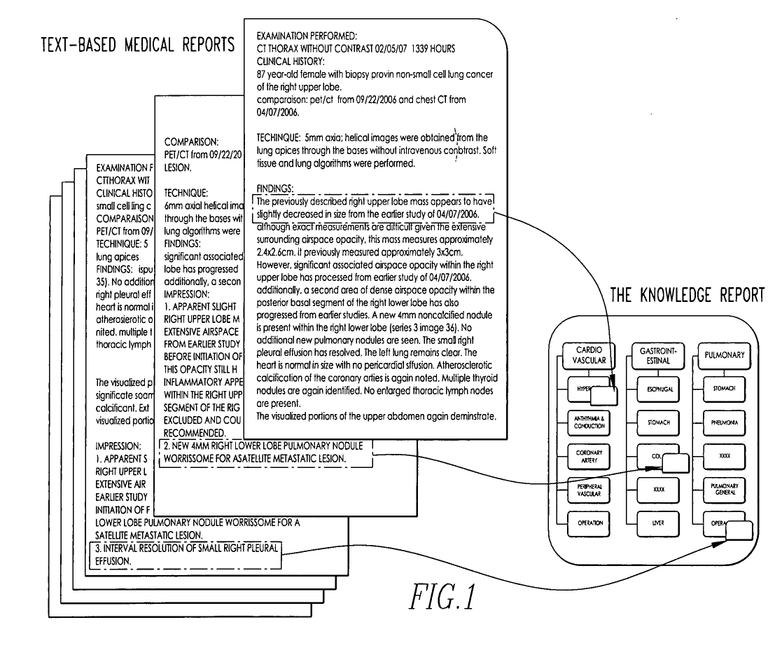

An important feature in this invention is that the original sentences, paragraphs or phrases from the text-based reports are presented in an organized manner according to the user requirement. In the presentation module, no information (i.e. sentences, paragraphs, and phrases) is modified or synthesized. FIG. 1 illustrates the key concept of this invention. As shown in the figure, a sentence, paragraph, or phrase in the text-based medical reports are processed without any modification and mapped to the pre-established categorization hierarchy and presented accordingly. It is believed clinicians would be the best decision maker of the given information and no machine could represent the original information without any slightest errors if the content is modified or synthesized by the machine. Further processing of original information only could degrade and could lead to misinformation. In summary, this invention allows clinicians to have an access to the critical information quickly without having to access and read entire text-based medical records.

The following illustrates an example of a possible implementation of the invention.

The system 10 consists of 5 major components as shown in FIG. 2. Text-based medical reports are retrieved from the external database through the Data interface 32. The function of the Data interface 32 is to retrieve designated medical reports from the database according to the patient name, identification number, or any other identification parameters by which the medical reports are stored in the database. The retrieved reports are stored in the internal database. The Knowledge Report Browser is a software module that presents the knowledge reports of patients. Clinicians use this module to view the overall knowledge report created from the patient's text-based medical reports. The Text Report Analyzer is a software module that analyzes the text-based reports. It parses the formats of the text-based reports and processes the contents into a form such that the knowledge reports can be generated. The Knowledge Search is a software module that provides a search into the contents of text-based reports. While knowledge reports are built one per patient, the Knowledge Search provides a functionality to search through the knowledge reports of all patients using any keywords. The results are summarized based on knowledge indices. All three applications are configured and managed by the Config and management component 40.

The Knowledge Report Browser and the Knowledge search modules 38 are a form of interface to extract data from the internal databases. Many existing browsing and search methods could be applied here.

The Text Report Analyzer, as shown in FIG. 3, is described. The text-based reports retrieved from the external database through the Data interface 32 are then input to the Text Report Analyzer. The Text Report Analyzer consists of 4 modules: The Text Report Parser, The Semantic Analyzer, The Knowledge Report Manager, and the Rule Base Engine.

The Text Report Parser performs two main functions. The first is to parse and partition lines of texts in the text-based reports into phrases, sentences, paragraphs (blocks of sentences), and sections. The second is to build a catalogue of all words appearing in the text-based reports. Input to the Text Report Parser is a text-based report in an electronic form. The output of the Text Report Parser is the parsed and indexed contents of the text-based report in database tables, so that the categories to sentences can be assigned and further presented according to the pre-established rules. All contents of the text-based reports are processed and stored, no information is lost. As no information is discarded, the original text-based report can be reassembled from the contents in the database tables. Computing of the checksum occurs in this module to assure the integrity of the content in the original text-based reports.

The Semantic Analyzer takes the output of the Text Report Parser, and analyzes the semantics of sentences, paragraphs, and phrases. The main function of the Semantic Analyzer is to classify each sentence, paragraph, and phrase according to pre-defined medical categories. This module manages the assignment, reassignment, and de-assignment of categories to sentences, paragraphs, and phrases. The Semantic Analyzer uses the Rule Base Engine. The Rule Base Engine matches category assignment rules and returns one or more candidate categories. The Semantic Analyzer then determines which category (or categories) to assign to a given sentence, paragraph, or phrase.

The category assignment rule assigns a category to a sentence, paragraph, or phrase. It is in the form of IF <rule condition>THEN category. The rule condition could be the existence of a condition, combination of conditions determined by Boolean logics such and “AND”, “NOT”, or “OR”. These rules could also be based on word, report type, or report section type. In other words, the rule condition may be based on the existence of the word, requested sentence, paragraph, or phrase coming from a particular report type or belonging to a particular report section as well.

The Rule Base Engine is a module that manages all rule bases used in the system 10. A rule base is a set of rules. For example, all category assignment rules form a category assignment rule base.

A rule base is a collection rules grouped in two basic structures; a rule set and a rule list. The rule set is an unordered list of rules. When matched, all rules in the set are matched and the categories of all matching rules are returned. Matching a rule set is equal to matching to the union of the set. A rule can belong to more than one rule set. The rule list is an ordered list of rules. Rules are matched in order, and the category of the first matching rule is returned. When a rule is matched in the list, the resulting category is returned and the process stops. A rule can belong to more than one list. A priority number could be assigned to both the rule set and the rule list. Thus the category assignment could be determined based on the priority number. The two structures, the rule set and the rule list, can be defined recursively. A rule set can have another rule set or a rule list, and a rule list can contain another rule set or a rule list. The Rule Base Engine maintains the rules, the rule set, and the rule list through -editing and indexing. The Rule Base Engine also returns the matched category according to the rule, the rule set, or the rule list when a request is made to categorize a sentence, paragraph, or phrase.

The Knowledge Report Manager manages all knowledge reports. It builds a knowledge report for each patient, and updates an existing report with new and updated sentences, paragraphs, or phrases. The Knowledge Report Manager creates all required components of the knowledge reports and stores them in a database according to a pre-set form, so that the presentation of the knowledge report to the user requires minimum operations. Only new or updated sentences, paragraphs, or phrases are added to the previously built knowledge report instead of rebuilding the entire knowledge report.

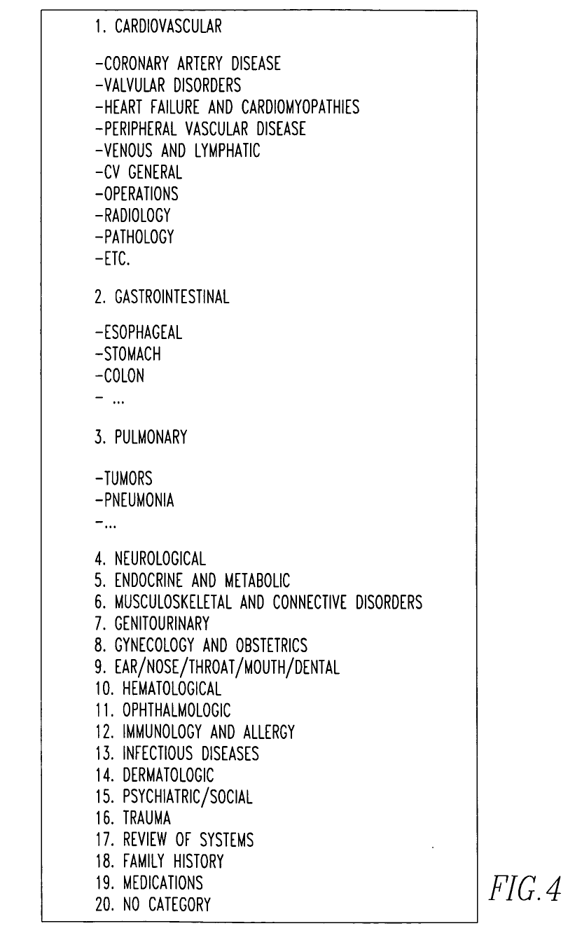

The knowledge report shows the entire patient data in terms of a medical system framework. The medical system framework describes the medical system organized according to the treatment areas or any other customized fields. The medical systems are categorized into a hierarchy, and the contents of text-based reports are divided and distributed into the appropriate categories. One possible way to organize the medical system is according to the medical specialty areas. This example is shown in FIG. 4. The sentences, paragraphs, or phrases that are determined to belong to a category in the medical system as shown in FIG. 4 are mapped and grouped. The grouping of sentences, paragraphs, or phrases could be based on different rules. One rule could dictate that the sentences, paragraphs, or phrases are grouped if they contain the same keywords or combination of the keywords. Another rule could dictate that they are grouped if they belong to the same section of the original text-based report. Other more complex rule could be possible by combining the existence of the keywords and the report types. Once the sentences, paragraphs, or phrases are grouped, one representative sentence, paragraph, or phrase is selected based on a presentation rule and the rest of the sentences, paragraphs, or phrases in the group could be hidden in the presentation but invoked if necessary for the purpose of simplification. The presentation rule could be based on a chronological order, complexity of the sentence, paragraph, or phrase, the priority rating of keywords, or any other metrics.

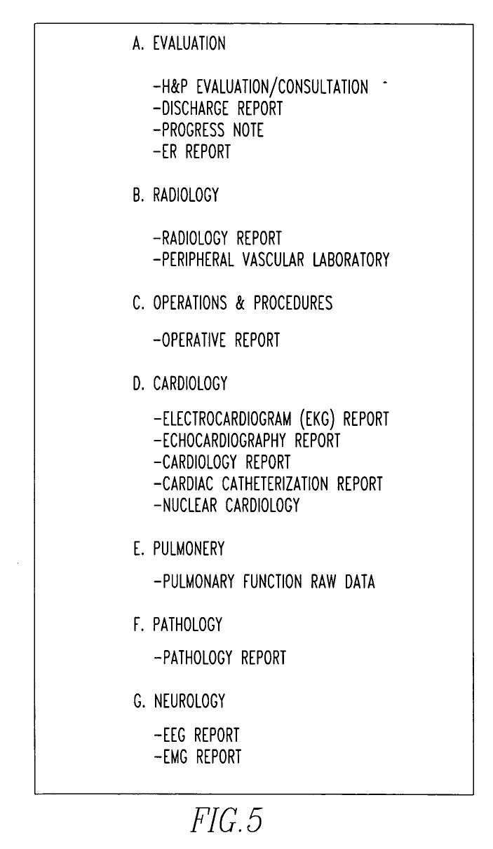

Another way to organize the knowledge report is according to the types of the text-based reports. This example is shown in FIG. 5. Grouping of the text-based reports are based on the type of text-based reports and the representative text-based report could be presented according to the similar presentation rule mentioned earlier.

Sometimes the context of where the sentence, paragraph, or phrase is coming from provides important information. Thus this invention also links the presented sentence, paragraph, or phrase in the knowledge report to the original text-based report and shows the entire original text-based report with the sentence, paragraph, or phrase highlighted in the original text-based report. The link of the sentence, paragraph, or phrase in the knowledge report to the original text-based report can be invoked by numerous input methods including clicking of the sentence, paragraph, or phrase and clicking a button in the knowledge report.

The invention can be implemented in a single computing device with multiple database servers or in a distributed environment where each of the multiple computing devices operates a part of the software modules and interconnected by computer networks.

Unified System View of Patient Records from Heterogeneous EMR Systems 14

Many large hospital systems have numerous hospitals and each hospital likely has different EMR system 14. Thus the patient data are distributed in many different EMR systems 14. Retrieval of a comprehensive medical data on a patient in numerous hospitals is almost impossible and it is very expensive and time consuming operation. Most systems that attempt to unify the medical records in heterogeneous EMR systems 14 are based on manual mapping schemes. One would map a particular field in an EMR system 14 to a common field. Once all mapping of data fields are completed, then the existing EMR systems 14 could be mapped to a common data field. The problems with such system are as follows.

1) It could only deal with template based EMR systems 14. Text reports cannot be processed in a template based EMR system 14 and it cannot be mapped to any common data fields.

2) The mapping has to be done manually for each data field in each EMR system 14 to a common data field. It is very expensive and time consuming

3) If any of existing EMR system 14 is updated or expanded, the mapping of data field has to be updated as well and again it relies on manual mapping.

Thus, it is a continuous mapping as the software gets updated.

The system 10 is not based on a template and does not require data field for processing of information. The system 10 process textual contents according to the medical system view. Thus, as long as an EMR system 14 can generate a complete text report of a patient, the system can gather all text reports and generates a comprehensive patient view. Most EMR systems 14 have a feature to generate a text report based on patient data in the system 10.

Thus, the system 10 can easily unify all patient data regardless of how diverse and different EMR systems 14 the patient data reside. The system 10 does not require any manual mapping or changes when these EMR system 14 get upgraded.

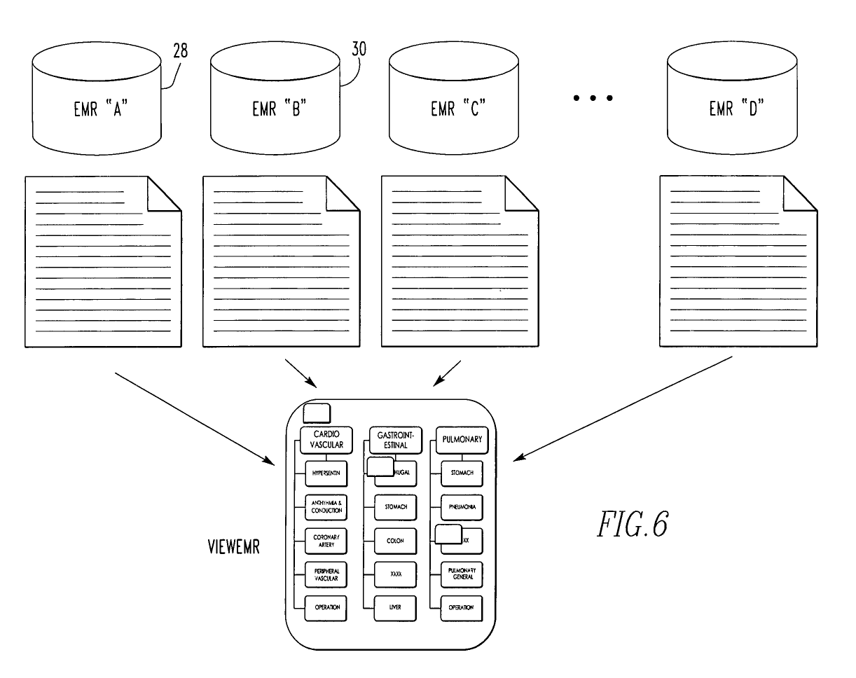

Text reports form a basic common denominator for the system 10 to be able to unify patient information regardless of number or heterogeneousity of EMR systems 14. See FIG. 6.

Workflow Description of Unified EMR System 14

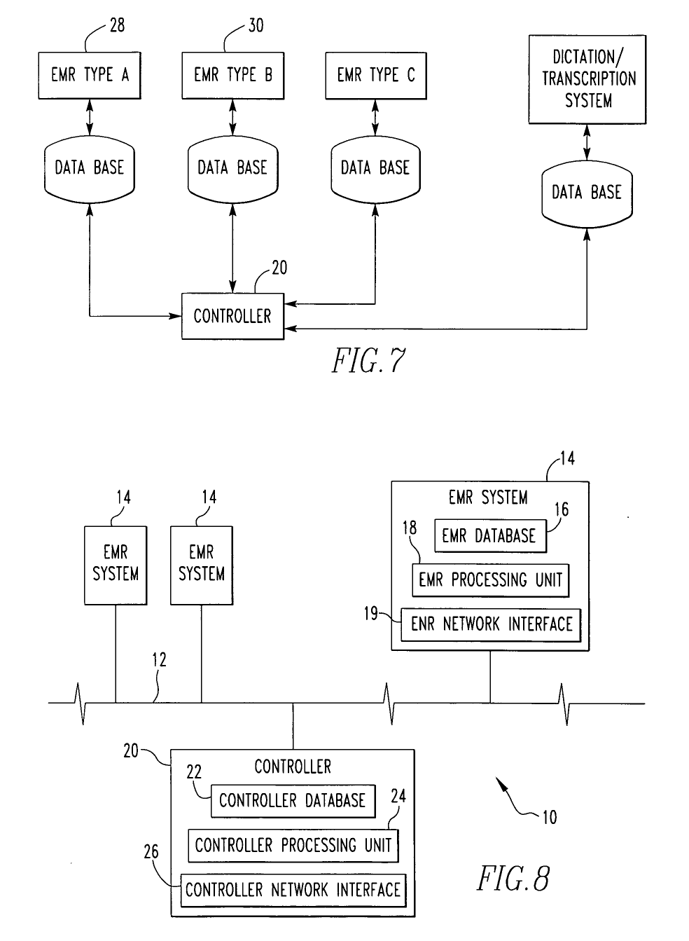

The unified EMR system 14 is now expanded upon. FIG. 7 describes the inter-EMR system 14 communication channels. Various existing EMR systems 14 can be categorized as follows:
Type A: EMR system 14 contains only template-based data entry. The patient information is tagged according to the data entry field information only. There is no text data (i.e. physician's report in text form). The clinicians enter patient information either by selecting the right selection or enter a word or two in designated fields (i.e. name, birthday, blood pressure, bone density, etc.). The Type A system, however, generates a pre-formatted text report for physicians in other hospital systems by inserting right tag information in pre-designated part of the report. (Similar to a pre-formatted credit card offer letter with names, address, etc. as a variable).
Type B: EMR system 14 contains both template-based data entry and text-report entry. This system contains Type A fields and also allows users to enter a text report (without any tagging) in the system. Thus, Type B can generate two types of text-reports: one from template-based data information in a pre-formatted report and the other one is an exact copy of the text-report entered by the user without any modification.
Type C: EMR system 14 contains a simple template-based entry and text-report entry. It is similar to Type B but it does not have an extensive template based field as in Type B. The template-base entries are mostly identification information (i.e. name, birthday, SSN, address, etc.) only. Most of patient health information is based on text-report based entry (i.e. it would have a field saying “diagnosis” and the user would enter a text report of diagnosis in that field. Other field would be “medication” or “Surgery”. Again this system would generate a pre-formatted text report by copying the exact text report content without modification except adding a field title such as “diagnosis”, “medication”, “surgery”, etc.
Dictation/Scanned/Transcription system:
   Dictation: A user dictates the report in a recorded format that could be stored in electronic form and the diction is entered into a text report file by a typist. These files could be organized according to the patient, physicians, hospitals, etc.
   Scanned: hand-written reports are scanned electronically and entered into the system. These files could be organized according to the patient, physicians, hospitals, etc.
   Transcription: either hand-written reports or scanned documents are entered into a text report file by typists. These files are stored according to patient, physicians, hospitals, etc.

All EMR systems 14 eventually generate text reports of patient regardless of data entry methods and these text files are stored either in file system or databases. The system collects these text report files with identification tags and processes on the system (parsing, classification, and presentation as in FIG. 2).

Communication channel: the arrows connecting to the system 10 as shown in FIG. 7 represent communication channel between existing EMR system 14 and the system 10. This communication could be accomplished in several ways.
Geographically separated
VPN: the database of an EMR system 14 is connected to the system 10 through a Virtual Private Network channel with proper encryption and security features
SSH: channel could be used to communicate via web API (i.e. https)

Within the same site, private channels are used within the cluster (i.e. server cluster) and they could be either encrypted or unencrypted.

If an EMR system 14 does not generate a pre-formatted text report, the system 10 could generate a pre-formatted text report by directly enquiring the each data field information from the existing EMR system 14 and thus composing a text report. (Type D: one that does not generate a text report).

Data Linkage and Consistency

It is important that a link is left between the parsed database model and the actual text report from existing EMR text report database.

Data linkage is defined as a way to relate two or more database entry from existing EMR system 14 to the system 10. The reason for the linkage is to be able to validate the integrity of the data and also efficiency of the storage. There are two types of linkage: direct and indirect.

Direct linkage: In this method, the database entry is linked to database entries from different existing EMR system 14 by a given identification tag. The database entry would contain identification tag that maps the location and chronological information of the data in the existing EMR database 16 (i.e. it could be a particular database query command along with the IP address of the database or any network address and authentication (id and password)). Thus, the report is not replicated from the existing EMR database 16.

Indirect linkage: In this method, the system 10 replicates the text reports of the patient from the existing EMR database 16 to the database and reorganizes them collectively if there are multiple sources. Despite the reorganization (i.e. different database schema for the organization sake), the content of text reports in the system 10 would be exact copies of the original reports from existing EMR systems 14. The linkage information would be still there for validation purpose. Database query command would be unnecessary as the system 10 already has a copy of the file. However, IP address or network address along with authentication information would be still required. According to HIPPA, once a report has been signed off by a clinician, there cannot be any modification. Thus, when the report is obtained, according to HIPPA, the report cannot be altered and the system 10 will contain the correct data. However, the system 10 has the capability to check for any changes in the data (text report of existing system 10) in the existing EMR system 14 such that the system 10 can update to the latest modification. In theory, this should never happen as it is against the HIPPA regulation. But there is the option to make sure that the data is correctly synchronized if there is any change.

Consistency: along with synchronization of data due to possible modification as mentioned in previous paragraphs, the integrity of the text report information is also checked by checking the byte size, date, and hashing the content itself for signature matching to assure that the data is exactly the same as in the existing EMR system 14.

Data Collection: the text reports or field data from existing EMR system 14 can be collected in either batch mode or in real time. In a batch mode, the system 10 enquires the change in the existing EMR database 16 and collects the changes incrementally in a batch mode at a given time of a day (i.e. 2:00am everyday). In real-time mode, the changes are constantly monitored in the existing EMR database 16 and when a change is detected, new reports are collected and processed real-time. Given the mode of clinician's work flow, the batch mode processing at odd hours would be sufficient and would give less burden on communication and computational overhead.

Workflow Example:

Let's assume that there are two EMR systems 14 and one user. There are 3 phases of workflow (user example): Data collection, Data processing, Data presentation.

Bulleted list happens mostly in chronological order.

Usage Examples

Let's assume that there are two EMR systems 14 and one user. There are 3 phases of workflow (user example): Data collection, Data processing, Data presentation.

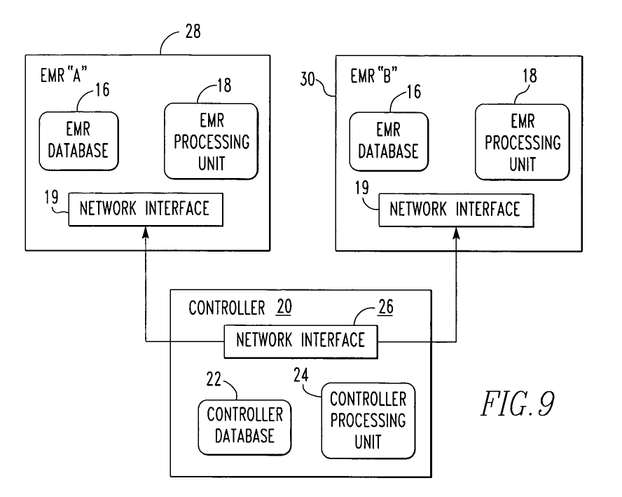

Bulleted list happens mostly in chronological order.
1) Data collection: (see FIG. 9)
   a. Controller processing unit 24 contacts EMR “A” and EMR “B” for data collection. This collection happens in various dates.
      i. In Dec. 3, 2007, Patient's data (clinician's report on his heart condition) is retrieved from EMR “A”. The report mentions various medical condition including “contains aortic dissection from left subdlavian artery to renal arteries, size of 5 cm”.
      ii. In Oct. 3, 2008, Patient's data (radiologist's report after the patient encounter) is retrieved from EMR “B”. It states that “CT scan results shows left subclavian artery dissection of 4 cm”.
      iii. In Nov. 17, 2008, Patient's data (cardiologist's report after the patient encounter) is retrieved from EMR “B”. It states that “stress test is ordered for the patient” as well as other medical conditions and also states that the patient has “Percocet” allergy.
      iv. In Feb. 3, 2009, Patient's data (vascular surgeon's report after the patient encounter) is retrieved from EMR “A”. It states that “patient had a congestive heart failure in Feb. 1, 2009” as well as other medical conditions.
      v. In Feb. 10, 2009, Patient's data (different vascular surgeon's operation report) is retrieved from EMR “B”. It states that “Endovascular AAA procedure was performed on the patient” as well as medical prescription with 3 heart medications and suggested follow-up. It also mentions “no known allergy”.

At Each Different Date, Below Procedure Happens.
b. When EMR “A” and EMR “B” gets the notification from the controller processing unit 24, they extract the relevant reports from their respective EMR database 16 and send them through their respective network interface to the controller network interface 26.
   i. The relevant reports could be either text based reports residing in the EMR database 16 or could be text reports “generated” by EMR processing unit 18 using the template or data field information internally.
c. When Controller network interface 26 gets these reports, the controller processing unit 24 stores the retrieved reports in the controller database 22.
d. After the reports are stored in the controller database 22, the controller processing unit 24 checks the integrity of the report by checking the byte size, date, and ID.

At Each Different Date, Below Procedure Happens.

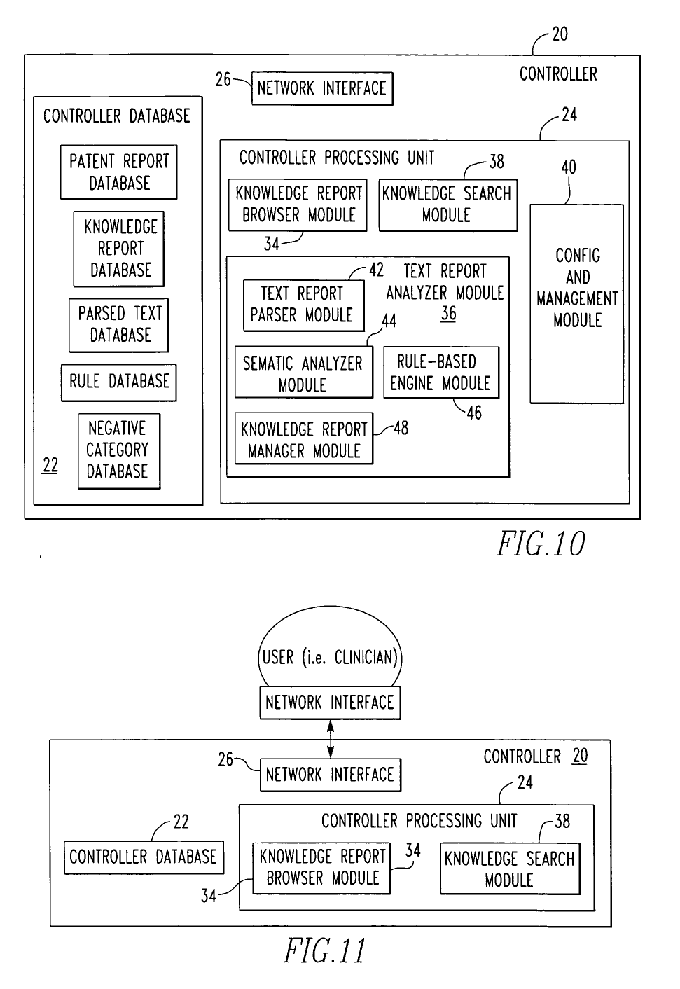

2) Data Processing (see FIG. 10)
a. Rule-based engine module 46 contains the pre-built rules for classification according to medical categories.
b. Text report parser module 42 retrieves a text report (new one that was not processed previously) from the Patient report database and
   i. parses texts and partitions into phrases, sentences, paragraphs and sections.
   ii. Also builds a catalog of all words appearing in the text reports and stores the catalog (or add entries to the catalog) in the rule database.
   iii. Checks the integrity of the original text report by checking the byte size, date, hashing of the text report content for signature matching and ID.
c. The semantic analyzer module 44
   i. classifies parsed phrases, sentences, paragraphs and sections using the rule-based engine module 46 and stores them in the parsed text database.

In Dec. 3, 2007,

Sentence containing “aortic dissection from left subdlavian artery to renal arteries, size of 5 cm” is classified to “Aortic Disease” category and placed with corresponding date. Classification occurred as the phrase “aortic dissection” matched the rule in “Aortic Disease” category by the rule-engine.

In Oct. 3, 2008,

Sentence containing “CT scan results shows left subdlavian artery dissection of 4 cm” is classified to “Aortic Disease” category and placed with corresponding date. Classification occurred as the phrase “artery dissection” matched the rule in “Aortic Disease” category by the rule-engine.

In Nov. 17, 2008,

Sentence containing “stress test is ordered for the patient” is classified to “Cardiovascular General” category and placed with corresponding date. Classification occurred as the phrase “stress test” matched the rule in “Cardiovascular General” category by the rule-engine.

Sentence containing “Percocet allergy” is classified to “Allergy” category and placed with the corresponding date. Classification occurred as the phrase “allergy” matched the rule in “Allergy” category by the rule-engine.

In Feb. 3, 2009,

Sentence containing “patient had a congestive heart failure in Feb. 1, 2009” is classified to “Heart Failure and Cardiomyopathies” category and placed with corresponding date. Classification occurred as the phrase “congestive heart failure” matched the rule in “Heart Failure and Cardiomyopathies” category by the rule-engine.

In Feb. 10, 2009,

Sentence containing “Endovascular AAA procedure was performed on the patient” is classified to “Peripheral vascular disease” category and placed with corresponding date. Classification occurred as the phrase “Endovascular AAA” matched the rule in “Peripheral vascular disease” category by the rule-engine.

Phrase containing “no known allergy” is classified to “Allergy” category and placed with the corresponding date. Classification occurred as the phrase “allergy” matched the rule in “Allergy” category by the rule-engine. Also it matched “no allergy” in negative classification and it was tagged with negative sentence tag.
d. The knowledge report manager module 48 builds the knowledge report for each patient (new knowledge report if patient is new, or modifies the existing knowledge report of the patient by adding additional new reports if the patient already exists) and stores in the knowledge report database.

In each date, the knowledge report is built by adding these sentences to appropriate categories.

3) Data Presentation (see FIG. 11)
a. A user or multiple users access the system 10 through a network interface.
b. Request from the user is handled by the knowledge report browser module 34 and the knowledge search module 38.
c. A user requests a particular patient for a set of patients.
d. The knowledge report browser module 34 retrieves the relevant knowledge reports from the knowledge report database in the controller database 22.
e. The knowledge report browser module 34 sends the knowledge report to the user according to the request.
f. The user checks the knowledge report and drills down to a particular sentence and requests the original text report where that particular sentence came from.
g. Upon receiving that request form the user, the knowledge report browser module 34 accesses the tagged original report from the patient report database. The tagging of the sentence to link the sentence to the original report occurred during the parsing by the text report parser module 42.
h. The knowledge report browser sends the requested original report to the user through the network interface.
i. The user wants to search for a particular phrase and request search command to the system 10 through the network interface.
j. The knowledge search module 38 receives the search command and search through the knowledge report database.
   i. The search could be done for an individual patient or across a set of patients.
   ii. The search index was built during the data processing phase.
k. The knowledge search module 38 sends the obtained results to the user through the network interface.

In Oct. 30, 2008,

Vascular surgeon access ViewEMR system and checks “Aortic Disease” category and sees that there are two sentences containing “aortic dissection from left subdlavian artery to renal arteries, size of 5 cm” and “CT scan results shows left subdlavian artery dissection of 4 cm”.
The vascular surgeon decides to treat the patient with the medication only.
Without this information, surgery would be necessary and would have been unnecessary and harmful.

In Dec. 30, 2008,

Vascular surgeon encounters the patient and he complains chest pain. The surgeon accesses the ViewEMR and sees the sentence containing “stress test is ordered for the patient” in “Cardiovascular General” category.
The vascular surgeon decides to look for the results of the stress test only.
Without this information, the surgeon has to order another stress test which is unnecessary and could be harmful.

In Mar. 10, 2009,

Billing department is going through the procedures for insurance claim. Looking at the list of Operation Report in the ViewEMR, one encounters “Endovascular AAA procedure”. The personnel search for “congestive heart failure” in the ViewEMR search function and finds the sentence containing the phrase in Feb. 3, 2009.
The billing personnel decides to claim for Endovascular AAA with complex DRG with provable records, thus for $26,000.
Without this information, the billing has to claim Endovascular AAA with simple DRG which would only be $14,000.

In Mar. 20, 2009,

Physician reviews the patient record in ViewEMR for patient's history before prescribing medication. He finds that there are two sentences that contradicts in “Allergy” category. Prior record with “Percocet Allergy” and later record saying “no allergy”.
The physician contacts the clinician to double check for the allergy and conclude that the patient has “Percocet” allergy and do not prescribe “Percocet”
Without this information, patient would be prescribed to “Percocet” and would be endangered.

Four examples are now described:
1) EMR systems 14 in different hospital system: Patient comes from ERIE hospital system to PITT hospital system. In ERIE hospital's EMR system, there is a report that details a heart condition. The patient has a surgery (aortic dissection from left subclavian artery to renal arteries, size of 5 cm) 2 years ago. This patient shows up at PITT hospital system with a chest pain. A CT scan is ordered and it is showing the same problem. There are two possible treatments to this problem depending on amount of information available to the clinician. If the clinician is not aware of the previous procedure in ERIE, a surgery would be necessary and would have been unnecessary and harmful. However, the system presents an unified view of patient records from two different hospital system with all historical reports and the clinician would treat the patient with the medication only.
2) EMR systems 14 within the same hospital system: The patient went through a stress test in 2008 in one of the PITT hospital system (i.e. Passavant Hospital). The patient shows up at the Shadyside Hospital and is diagnosed with colon cancer. Without the prior information about the stress test stored in Passavant Hospital system, the clinician at Shadyside Hospital has to order another stress test which is unnecessary and could be harmful. With ViewEMR system's view of two records ((a) stress test results in Passavant hospital's EMR system record and (b) colon cancer diagnosis in Shadyside hospital's EMR system record), the clinician does not need to repeat the procedure.
3) Billing accuracy: Billing department is filing a claim to the health insurance company on a procedure done to the patient. Endovascular AAA is the procedure performed to the patient. There are two different types of claims that can be made on this procedure: Simple DRG (for patient with very little medical condition) and complex DRG (for patient with medical conditions such as “congestive heart failure”). The reimbursement for the simple DRG would be $14,000. The reimbursement for the complex DRG would be $26,000. It is extremely difficult to extract medical condition of the patient at the time of the procedure in current systems as they need to go through hundreds of medical reports and also need to verify the case from the performing surgeon. Thus, the billing department usually files the claim for Endovascular AAA with simple DRG for $14,000. With ViewEMR system, where the comprehensive view of the patient records is presented and also with an ability to search the records, the billing department could find the medical condition of the patient at the time of surgery by searching for “congestive heart failure” in the records during that time period and files for Endovascular AAA with complex DRG with provable records.
4) Error prevention: by having historical record in a simple overview and an ability to search, many medical errors could be prevented.
   a. In hospital A, the report shows that the patient was treated with 3 heart medications. When the patient shows up at hospital B, he mentions that he is taking heart medications without specifying 3 medications. Without the comprehensive view of the patient records from various hospital EMR systems 14, the clinician prescribes 2 heart medication and it could have caused the death of the patient. With historical records shown from the ViewEMR system, the clinician would have prescribed 3 heart medication and would have prevented patient mortality.
   b. Errors in Patient reports occur frequently. The patient is known to have an allergy to Percocet in 2007. Somehow, one of the clinician noted that the patient has no allergy (maybe that's what patient stated in his first interview with the nurse in 2008) and the report is filed. From that point on, the clinicians only reads the latest report and propagate the error by stating “no allergies”. In ViewEMR system, the inconsistency of allergy is found by detecting positive sentence (Percocet allergy) followed by negative sentence (no allergy) in Allergy category of the medical system. Thus, the medical error could have been prevented.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A system for processing medical reports having health information about a patient comprising:
a network;
a plurality of EMR systems, each EMR system having an EMR database and an EMR processing unit, the processing unit of at least one EMR system generating a text report having health information for the patient, each EMR system remote from each other EMR system and in communication with each other through the network; and
a controller having a controller database and a controller processing unit which automatically collects the text reports for the patient from the plurality of EMR systems, or produces text reports for the patient from data in the EMR database of at least one EMR system, the controller maintaining a linkage for each report between the controller database and the EMR database from which each report arose.

2. The system as described in claim 1 wherein the controller has a controller network interface and each EMR has an EMR network interface, the controller processing unit communicating with the EMR databases through the controller network interface and the EMR network interfaces to collect text reports of patients and store the text reports in the controller database with an ID that identifies patients and associated text reports.

3. The system as described in claim 2 wherein at least a first EMR system of the plurality of EMR systems is different from a second EMR system of the plurality of EMR systems.

4. The system as described in claim 3 wherein the controller processing unit collects the text reports from the EMR systems not based on a template or a data field.

5. The system as described in claim 4 wherein the first EMS system contains only template-based data.

6. The system as described in claim 5 wherein the second EMR system contains both template based data and text reports.

7. The system as described in claim 6 wherein the linkage includes a direct linkage where the text report and the controller database has an identification tag that maps a location in chronological information of the data and the EMR database from which the text report arose.

8. The system as described in claim 7 wherein the linkage includes an indirect linkage wherein the controller processing unit replicates the text reports of the patient from EMR databases to the controller database and organizes them collectively when there are multiple sources for the text report from multiple EMR databases.

9. The system as described in claim 8 wherein the controller processing unit checks the integrity of the text report information by checking the byte size, date, and hashing of the text report content for signature matching to ensure that the data in the controller database is exactly the same as in the associated EMR system.

10. The system as described in claim 9 wherein the controller processing unit collects text reports or data from the EMR system in either batch mode or in real-time.

11. A method for processing medical reports having health information about a patient comprising:
generating a text report having health information for the patient with a processing unit of at least one EMR system of a plurality of EMR systems, each EMR system remote from each other EMR system and in communication with each other through a network; and
automatically collecting with a controller processing unit of a controller text reports for the patient from the plurality of EMR systems, or producing text reports for the patient from data in an EMR database of at least one EMR system, the controller maintaining a linkage for each report between a controller database and the EMR database from which each report arose.

12. The method as described in claim 11 including the steps of the controller processing unit communicating with the EMR databases through a controller network interface and EMR network interfaces to collect text reports of patients and storing the text reports in the controller database with an ID that identifies patients and associated text reports.

13. The method as described in claim 12 wherein at least a first EMR system of the plurality of EMR systems is different from a second EMR system of the plurality of EMR systems.

14. The method as described in claim 13 wherein the collecting step includes the step of the controller processing unit collecting the text reports from the EMR systems not based on a template or a data field.

15. The method as described in claim 14 wherein the first EMS system contains only template-based data.

16. The method as described in claim 15 wherein the second EMR system contains both template based data and text reports.

17. The method as described in claim 16 wherein the linkage includes a direct linkage where the text report and the controller database has an identification tag, and including the step of mapping a location and chronological information of the data in the EMR database from which the text report arose.

18. The method as described in claim 17 wherein the linkage includes an indirect linkage and including the steps of the controller processing unit replicating the text reports of the patient from EMR databases to the controller database and organizing them collectively when there are multiple sources for the text report from multiple EMR databases.

19. The method as described in claim 18 including the step of the controller processing unit checking the integrity of the text report information by checking the byte size, date, and hashing of the text report content for signature matching to ensure that the data in the controller database is exactly the same as in the associated EMR system.

20. The method as described in claim 19 including the step of the controller processing unit collecting text reports or data from the EMR system in either batch mode or in real-time.

21. A system for processing medical reports comprising:
a network;
a plurality of EMR systems, each EMR system having an EMR database and an EMR processing unit, the processing unit of at least one EMR system generating a text report for a patient, each EMR system remote from each other EMR system and in communication with each other through the network; and
a controller having a controller database having a pointer to the text report in the EMR database and a controller processing unit which uses the text report in the EMR database for the patient at a desired time.

22. The system as described in claim 10 wherein the controller includes a data interface 32 which retrieves designated medical reports from at least one EMR database according to identification parameters by which the medical reports are stored in the EMR database and stores the designated medical reports and the controller database; a knowledge report browser module that presents knowledge reports of patients which the knowledge report browser module creates from the patient's textbased medical reports; a text report analyzer module that analyzes the textbased reports and parses the textbased reports' formats and processes the text based reports' contents into a form such that the knowledge reports can be generated by the knowledge report browser module; a knowledge search module that provides a search into the contents of the textbased reports; and a config and management component which configures and manages the knowledge report browser module, a text report analyzer module in the knowledge search module.

23. The system as described in claim 22 wherein the text report analyzer module comprises a text report parser module that parses and partitions lines of text in the textbased reports into phrases, sentences, paragraphs and sections; and builds a catalog of all words appearing in the textbased reports; a semantic analyzer module that takes the catalog of the text report parser and analyzes semantics of sentences, paragraphs and phrases to classify each sentence, paragraph and phrase according to predefined medical categories; a rule-based engine module that manages all ruled bases; and a knowledge report manager module that builds a knowledge report for each patient and updates an existing report with new and updated senses, paragraphs, or phrases.

24. The system as described in claim 23 wherein the text report parser module parses the phrases, sentences, paragraphs and sections into subcategories, chronologically, and also classifies them according to negative sentences, and groups similar sentence based on a similarity metric and chooses a representative sends to be a group head, where the representative sentences are stored in the controller database indexed with classification categories and keywords.

25. The system as described in claim 24 wherein all negative sentences within a category is stored in a separate database table and the controller database and all negative sentences are links to the EMR database from which the sentence arose, or any information presented by the controller from the controller database contains exactly identical information as found in the text report in the EMR database from which the data arose.

26. A controller comprising:
a data interface which retrieves designated medical reports from at least one EMR database according to identification parameters by which the medical reports are stored in the EMR database and stores the designated medical reports and the controller database; a knowledge report browser module that presents knowledge reports of patients which the knowledge report browser module creates from the patient's textbased medical reports; a text report analyzer module that analyzes the textbased reports and parses the textbased reports' formats and processes the text based reports' contents into a form such that the knowledge reports can be generated by the knowledge report browser module; a knowledge search module that provides a search into the contents of the textbased reports; and a config and management component which configures and manages the knowledge report browser module, a text report analyzer module in the knowledge search module.
